(19) United States
(12) Patent Application Publication
(10) Pub. No.: US 2008/0199360 A1
(43) Pub. Date: Aug. 21, 2008

(54) Method and composition for a platinum embedded sol gel optical chemical sensor with improved sensitivity and chemical stability

(75) Inventor: Mahmoud R. Shahriari, Palm Harbor, FL (US)

Correspondence Address: DENNIS L. COOK, ESQ.;THE LAW OFFICES OF DENNIS L COOK PLLC, 12718 DUPONT CIRCLE, TAMPA, FL, 33626, US

(73) Assignee: Ocean Optics, Inc., Dunedin, FL (US)

(21) Appl. No.: 11/706,893

(22) Filed: Feb. 16, 2007

(51) Int. Cl. G01N 21/64; B05D 5/00

(52) U.S. Cl. 422/82.06; 427/162

(57) ABSTRACT

A process for manufacturing a material, (medium or matrix) to hold or encapsulate sensing molecules with enhanced sensitivity to oxygen gas and dissolved oxygen by mixing a platinum compound with sol-gel monomers and then coating the tip of an optical fiber is disclosed. The sol-gel polymerizes, trapping the platinum compound in an oxygen permeable glass like solid. The high quenching efficiency of the Pt compound upon oxygen exposure makes the sensor extremely sensitive to oxygen partial pressure variations and also resistant to exposure to hydrocarbons.

### CROSS-REFERENCE TO RELATED APPLICATION

The present application claims the benefit of previously filed co-pending Provisional Patent Application, Ser. No. 60/773,408 filed Feb. 15, 2006.

### FIELD OF THE INVENTION

This invention belongs to the field of optical chemical sensors based on fluorescence detection using indicator molecules or substances. Specifically, it relates to sensors based on the absorbance and emission of light by an indicator molecule where the optical properties of the indicator molecule change in response to a particular analyte. These indicator molecules are typically immobilized in a transparent substance that is exposed to light, where the substance is typically a solid such as a rigid sol-gel or other polymer. More specifically, it is a new process for the manufacture of a material, (medium, or matrix) that holds or encapsulates sensing molecules. This new manufacturing method results in a production of an improved sensor with enhanced sensitivity to oxygen gas as well as dissolved oxygen.

### BACKGROUND OF THE INVENTION

This new material and method of manufacture thereof has an improved resistance to exposure to hydrocarbons. These materials are used to immobilize colorimetric and/or fluorescence indicators in an oxygen permeable hydrophobic matrix. An example is the immobilization of a Platinum (pt) porphyrin organic compound, which is used to sense molecular oxygen. This invention belongs to the field of optical chemical sensors based on fluorescence detection. It is a new process for manufacturing a material (a medium or matrix) to hold or encapsulate sensing molecules with enhanced sensitivity to oxygen gas and dissolved oxygen.

An example is the immobilization of a Platinum (Pt) organic compound, which is used to sense molecular oxygen. The platinum compound is mixed with the sol-gel monomers and then coated on the tip of an optical fiber. The sol-gel polymerizes, trapping the platinum compound in an oxygen permeable glass like solid. The high quenching efficiency of Pt compound upon oxygen exposure makes the sensor extremely sensitive to oxygen partial pressure variations.

The process is such that it allows for the deposition of extremely thin films directly onto sensor couplers or similar devices thereby reducing the amount of time and or distortion in sensor signal.

The sensor coating resulting from this invention can be used as a platform for making a number of sensors for monitoring gases, and dissolved gases in a wide range of environments where there is need to monitor traces of oxygen. Some of these applications include beverage industry, vacuum technology, food/pharmaceutical packaging and storage, and anoxide sediment environment.

More specifically, the sol-gel support medium resulting from this invention can be used as a platform for making a number of sensors for monitoring gases, and dissolved gases in a wide range of hydrocarbon liquids and vapors. There is a lack of effective optical sensors available for monitoring gasses in many fuels including jet, diesel and gasoline fuels. For example a fiber optic oxygen probe resulting from this invention can be used to monitor oxygen in a military and commercial fuel tank as part of an On Board Inerting Gas System (OBIGS) to protect the fuel tank from explosion. Other applications include: Oxygen monitoring in organic solvents, Oxygen monitoring during polymerization process, Oxygen monitoring in hydrocarbon streams, Oxygen monitoring during wine or alcohol fermentation, automotive fuel monitoring, and oxygen monitoring in vegetable, tallow, or other oil.

Indicator Molecules Chemical sensors are generally known for use in a wide variety of areas such as medicine, scientific research, industrial applications and the like. Fiber optic and electrochemical approaches are generally known for use in situations where it is desired to detect and/or measure the concentration of a parameter at a remote location without requiring electrical communication with the remote location. Structures, properties, functions and operational details of fiber optic chemical sensors can be found in U.S. Pat. No. 4,577,109 to Hirschfeld, U.S. Pat. No. 4,785,814 to Kane, and U.S. Pat. No. 4,842,783 to Blaylock, as well as Seitz, “Chemical Sensors Based on Fiber Optics,” Analytical Chemistry, Vol. 56, No. 1, January 1984, each of which is incorporated by reference herein.

For oxygen sensors, a ruthenium-based compound or “ruthenium complex” has been used as the fluorophore to provide the requisite fluorescence. The use of ruthenium complexes in oxygen sensors has been described in the following publications: Hartman, Leiner and Lippitsch, Luminescence Quenching Behavior of an Oxygen Sensor Based on a Ru(II) Complex Dissolved in Polystyrene, 67 ANAL. CHEM. 88 (1995); Carraway, Demas, DeGraff, and Bacon, Photophysics and Photochemistry of Oxygen Sensors Based on Luminescent Transition-Metal Complexes, 63 ANAL. CHEM. 337 (1991); and Bacon and Demas, Determination of Oxygen Concentrations by Luminescence Quenching of a Polymer-Immobilized Transition-Metal Complex, 59 ANAL. CHEM. 2780 (1987). In addition to ruthenium complexes, other fluorophores have also been used to detect oxygen, as described in the following publications: Wolfbeis, Posch and Kroneis, Fiber Optical Fluorosensor for Determination of Halothan and/or Oxygen, 57 ANAL. CHEM. 2556 (1985); and Wolfbeis, Offenbacher, Kroneis and Marsoner, A Fast Responding Fluorescence Sensor for Oxygen, I MIKROCHIMICA ACTA EEWIEN! 153 (1984). U.S. Pat. Nos. 5,176,882 to Gray et al., 5,155,046 to Hui et al., and 4,861,727 to Hauenstein et al. also disclose various fluorophores which may be used to detect oxygen.

Platinum compounds are specific to the object of this invention for improved performance in oxygen rich environments. Pt(II) Octaethylporphine and Pt(II) meso-Tetra (pentafluorophenyl) are used to provide for improved sensor ability and chemical stability.

Such indicator molecules are specific in their excitation and emission wavelengths. The fluorescent emission from an indicator molecule may be attenuated or enhanced by the local presence of the molecule being analyzed. For example, a tris (4,7-diphenyl-1,10-phenanthroline) ruthenium (II) perchlorate molecule particular for oxygen sensing is excited by shining light onto the substance at 460 nm (blue). The molecule's fluorescent emission immediately occurs at 620 nm (orange-red). However, the emission is quenched by the local presence of oxygen interacting with the indicator molecule, to cause the intensity of the fluorescence to be related to the ambient oxygen concentration. Consequently, the more oxygen that is present, the lower the emission intensity and vice-versa and when zero or no oxygen is present, the maximum fluorescent intensity of emitted light is present.

The quenching of the luminescence of an emitter at the end of an optical fiber has also been used in temperature sensors. For temperature probes the emitters are generally solid phosphors rather than an aromatic molecule embedded in plastic, since access by molecules from the environment is not desirable. Various methods have been used to measure the amount of quenching: (i) Quick et al. in U.S. Pat. No. 4,223,226 ratios the intensity at one wavelength of the emission against another; (ii) Quick et al. also proposes determining the length of time it takes for the signal to fall from one level to another; (iii) Samulski in U.S. Pat. No. 4,245,507 (reissued as U.S. Pat. No. Re. 31,832) proposes to measure quenching by determining the phase of the emitted life. In a patent for temperature sensing at the end of an optical fiber, Hirschfeld, in U.S. Pat. No. 4,542,987, proposes, in addition to method, that emission lifetime be used to measure quenching and that Raman scattered light can be used as a reference.

The fluorescence of the indicator molecules employed in the device described in U.S. Pat. No. 5,517,313 is modulated, e.g., attenuated or enhanced, by the local presence of the analyte. For example, the orange-red fluorescence of the complex, tris (4,7-diphenyl-1,10-phenanthroline) ruthenium(II) perchlorate is quenched by the local presence of oxygen. This complex can, therefore, advantageously be used as the indicator molecule of an oxygen sensor. Similarly, other indicator molecules whose fluorescence is affected by specific analytes are known.

Optical Sensing Devices The fluorescent indicators described above have classically been used in fluorescence spectrophotometers. These instruments are designed to read fluorescence intensity and/or the decay time of fluorescence. The indicator molecules and samples are classically in a solution or liquid phase and are assayed in discrete measurements made on individual samples contained in cuvettes.

Fluorescence indicators trapped in a solid substance typically are deposited as a thin layer or a membrane onto a fiber optic waveguide, the waveguide and trapped analyte forming a fiber optic sensor. The sensor is introduced to the sample in a manner such that the indicator will interact with the analyte. This interaction results in a change in optical properties, as discussed above, where this change is probed and detected through the fiber optic waveguide by an optical detector. The optical detector can be a single photo detector with an optical filter, a spectrometer, or any optical detection system capable of measuring light intensity or the change in light intensity through time. These optical properties of chemical sensor compositions typically involve changes in colors or in color intensities, or fluorescence intensity or fluorescence lifetime. In these types of sensors, it is possible to detect changes in the analytes being monitored at the tip of the fiber sensor by a detector which is located remotely to the sample, in order to thereby provide remote monitoring capabilities. In such systems, the amount of light reaching the detector will limit the sensitivity and signal to noise of the analyte measurement.

A second area of fluorescence sensor state-of-the-art is in fiber optic devices. These sensor devices allow miniaturization and remote sensing of specific analytes. The fluorescent indicator molecule is immobilized via mechanical or chemical means to one end of an optical fiber. To the opposite end of the fiber is attached a fiber coupler (Y shaped fiber) or a beam splitter. Incident excitation light is coupled into one leg of the fiber typically via a filter and a lens. Excitation light is carried via the fiber to the distal end where the fluorescent indicator molecule is immobilized to the tip.

Upon excitation, the indicator molecule uniformly radiates the fluorescent light, some of which is recaptured by the fiber tip and propagated back through the fiber to the Y junction or “coupler”. At the junction, a substantial portion (typically half) of the fluorescence is conveyed back to the emitter or point of origin thereby unavailable for signal detection. To offset the inefficiencies of the system, lasers are often used to raise the input power and highly sensitive photomultiplier tubes are used as detectors thereby raising costs by thousands of dollars. The other half travels along the other leg of the Y to the detector and is recorded.

U.S. Pat. No. 6,024,923, issued to Melendez et al. on Feb. 15, 2000, entitled Integrated Fluorescence-Based Biochemical Sensor, discloses an integrated biochemical sensor for detecting the presence of one or more specific samples having a device platform with a light absorbing upper surface and input/output pins. An encapsulating housing provides an optical transmissive enclosure which covers the platform and has a layer of fluorescence chemistry on its outer surface. The fluorophore is chosen for its molecular properties in the presence of the sample analyte. The detector and light sources are all coupled to the platform and encapsulated within the housing. A filter element is used to block out unwanted light and increase the detector's ability to resolve wanted emission light.

U.S. Pat. No. 5,910,661, issued to Colvin, Jr. on Jun. 8, 1999, entitled Fluorescence Sensing Device discloses a fluorescence sensing device for determining the presence or concentration of an analyte in a liquid or gaseous medium. The device is constructed of an optical filter, which is positioned on a photodetector and which has a thin film of analyte-permeable, fluorescent indicator molecule-containing material on its top surface. An edge-emitting, light-emitting P-N junction is positioned on the top surface of the optical filter such that the P-N junction from which light is emitted is positioned within the film. Light emitted by the fluorescent indicator molecules impacts the photodetector thereby generating an electrical signal that is related to the concentration of the analyte in the liquid or gaseous medium. Fluorescence sensing devices according to this invention are characterized by very compact sizes, fast response times and high signal-to-noise ratios.

U.S. Pat. No. 5,517,313, also issued to Colvin, describes a fluorescence sensing device comprising a layered array of a fluorescent indicator molecule-containing substance, a high-pass filter and a photodetector. In this device, a light source, preferably a light-emitting diode (“LED”), is located at least partially within the indicator material, such that incident light from the light source causes the indicator molecules to fluoresce. The high-pass filter allows emitted light to reach the photodetector, while filtering out scattered incident light from the light source.

None of these devices, however, incorporate a medium for the encapsulation of an optical sensor material that results in a sensor that is extremely sensitive to oxygen partial pressure variations.

Optical Sensors for Use in Detecting Oxygen Because oxygen is a triplet molecule, it is able to quench efficiently the fluorescence and phosphorescence of certain luminophores. This effect (first described by Kautsky in 1939) is called “dynamic fluorescence quenching.” Collision of an oxygen molecule with a fluorophore in its excited state leads to a non-radiative transfer of energy. The degree of quenching is related to the frequency of collisions, and therefore, to the concentration, pressure and temperature of the oxygen-containing media.

There are several issued patents that concern optical sensors designed to sense the presence of oxygen in addition to those devices described above.

An oxygen sensor based on oxygen-quenched fluorescence is described in U.S. Pat. Reissue No. 31,879 to Lubbers et al. Lubbers et al. describe an optrode consisting of a light-transmissive upper layer coupled to a light source, an oxygen-permeable lower diffusion membrane in contact with an oxygen-containing fluid, and a middle layer of an oxygen-quenchable fluorescent indicating substance, such as pyrenebutyric acid. When illuminated by a source light beam of a predetermined wavelength, the indicating substance emits a fluorescent beam of a wavelength different from the source beam and whose intensity is inversely proportional to the concentration of oxygen present. The resultant beam emanating from the optrode, which includes both a portion of the source beam reflected from the optrode and the fluorescent beam emitted by the indicating substance, is discriminated by means of a filter so that only the fluorescent beam is sent to the detector. In a second embodiment, the optrode consists of a supporting foil made of a gas-diffusable material such as silicone in which the fluorescent indicating substance is randomly mixed, preferably in a polymerization type reaction, so that the indicating substance will not be washed away by the flow of blood over the optrode.

U.S. Pat. No. 3,612,866, issued to Stevens, describes a method of calibrating an oxygen-quenchable luminescent sensor. The Stevens device includes an oxygen-sensitive luminescent sensor made of pyrene and, disposed adjacent thereto, an oxygen-insensitive reference sensor also made of pyrene but which is covered with an oxygen-impermeable layer. The oxygen concentration is evaluated by comparing the outputs of the measuring and reference sensors.

Substances Indicator molecules that are incorporated at the distal end of fiber optic sensors are often configured as membranes that are secured at the distal tip end of the waveguide device or optrode. The indicator-containing substance is typically spread as a thin layer or membrane for mechanical support. Sensors of this general type are useful in measuring gas concentrations such as oxygen and carbon dioxide, monitoring the pH of a fluid, and the like. Ion concentrations can also be detected, such as potassium, sodium, calcium and metal ions.

A typical fiber optic oxygen sensor positions the sensor material at a generally distal location with the assistance of various different support means. Support means must be such as to permit interaction between the oxygen indicator and the substance being subjected to monitoring, measurement and/or detection. With certain arrangements, it is desirable to incorporate membrane components into these types of devices. Such membrane components must possess certain properties in order to be particularly advantageous. Many membrane materials have some advantageous properties but also have shortcomings. Generally speaking, the materials must be selectively permeable to oxygen molecules, and of sufficient strength to permit maneuvering of the device without concern about damage to the oxygen sensor in addition to being inert and non-solvent to the environment in which measurements are to be taken.

It is known that a luminescent aromatic molecule embedded in plastic is subject to quenching by oxygen present in the gas or liquid in contact with the plastic. This phenomenon was reported by Bergman (Nature 218:396, 1966), and a study of oxygen diffusion in plastic was reported by Shaw (Trans. Faraday Soc. 63:2181-2189, 1967). Stevens, in U.S. Pat. No. 3,612,866, ratios the luminescence intensities from luminescent materials dispersed in oxygen-permeable and oxygen-impermeable plastic films to determine oxygen concentration. Lubbers et al. in U.S. Pat. No. 4,003,707, proposed the possibility of positioning the emitting substance at the end of an optical fiber. Peterson et al. in U.S. Pat. No. 4,476,870 also employs the quenching of an emitting molecule in plastic at the end of an optical fiber. Both Lubbers and Peterson reference emission against scattered exciting light.

According to the invention disclosed in U.S. Pat. No. 6,015,715, a sensitive single-layer system is produced in such a way that the fluorescence indicators are adsorbed on to a filling material, and in connection therewith a mixture is produced with a material permeable to the analyte to be investigated. The mixture produced is then compressed under the action of pressure, advantageously at an applied pressure of 12 to 20×10⁴ Pa, preferably 15×10⁴ Pa on a substrate, the layer thickness being formed in dependence on the applied pressure used. The sensitive layer thus applied is polymerized, polycondensed or hardened, this preferably being carried out in an extrusion mould to be used. The layer is additionally homogenized by swelling in a fluorescence indicator solution.

In the sensor described in U.S. Pat. No. 5,517,313, the material which contains the indicator molecule is permeable to the analyte. Thus, the analyte can diffuse into the material from the surrounding test medium, thereby affecting the fluorescence emitted by the indicator molecules. The light source, indicator molecule-containing material, high-pass filter and photodetector are configured such that at least a portion of the fluorescence emitted by the indicator molecules impacts the photodetector, generating an electrical signal which is indicative of the concentration of the analyte in the surrounding medium.

Another pO2 sensor probe utilizing an oxygen-sensitive fluorescent intermediate reagent is described in U.S. Pat. No. 4,476,870 to Peterson et al. The Peterson et al. probe includes two optical fibers ending in a jacket of porous polymer tubing. The tubing is packed with a fluorescent light-excitable dye adsorbed on a particulate polymeric support. The polymeric adsorbent is said to avoid the problem of humidity sensitivity found with inorganic adsorbents such as silica gel. The probe is calibrated by using a blue light illuminating signal and measuring both the intensity of the emitted fluorescent green signal and the intensity of the scattered blue illuminating signal. Again, none of these patents describe the high performance materials used as a medium and described in this disclosure.

In U.S. Pat. No. 6,139,798 issued to Klimant et al. on Oct. 31, 2000 entitled Sensor Membrane of an Optical Sensor, there is disclosed a sensor membrane of an optical sensor for detection of O.sub.2, H.sub.2 O.sub.2, SO.sub.2 or halogenated hydrocarbons in a sample. The membrane contains an indicator substance that is homogeneously immobilized in the polymer matrix of the sensor membrane and is, at least indirectly, in contact with the sample, changing at least one of its optical properties upon a change of the parameter to be measured. The indicator substance contains an inorganic salt of a transition metal complex with alpha-diimine ligands. The indicator substance is homogeneously distributed in the polymer matrix, which essentially consists of at least one substance belonging to the group of cellulose derivatives, polystyrenes, polytetrahydrofuranes, or their respective derivatives.

In U.S. Pat. No. 6,441,055 issued to Katerkamp et al. on Aug. 27, 2002, entitled Sensor Membrane For Determining Oxygen Concentrations And Process For The Preparation Thereof, there is disclosed sensor membranes for determining oxygen concentrations and to a process for the preparation thereof, in which, in a polymer matrix which is permeable to oxygen, an indicator is present whose optical and physicochemical properties can be influenced by the respective analytes. Starting from the disadvantages of known sensor membranes, it is the object of the Katerkamp invention to provide a sensor membrane which is thermally and also dimensionally stable, and can be prepared simply and flexibly. This object is achieved according to the invention in that the polymer matrix which contains the optical oxygen indicator is formed from a polymer containing sulfur, preferably in the main chain, particularly preferably containing sulfide and/or sulfone functionalities in the main chain.

In U.S. Pat. No. 6,254,829 issued to Hartmann et al. on Jul. 3, 2001, entitled Optochemical Sensor there is disclosed an optical sensor including a matrix containing a luminescence indicator whose luminescence may be quenched by oxygen. The optical sensor contains at least one agent capable of deactivating singlet oxygen and has an enhanced stability relative to oxygen.

The stability of a sensor against washing out of the indicator also is the topic of proposals in U.S. Pat. No. 5,070,158 to Holloway and U.S. Pat. No. 5,128,102 to Kaneko, which disclose the possibility of chemically binding indicator molecules to a polymer matrix. Another way of improving the stability of a sensor against the loss of its indicator and hence the deterioration of the photophysical properties of the membrane is set forth by Markle in U.S. Pat. No. 5,511,547. A special silicone matrix comprising polar carbinol groups serves to enhance the interaction between indicator (e.g., tris(4,7-diphenyl-1,10-phenanthroline)ruthenium(II) chloride) and matrix in order to reduce the washing out, and also the aggregation, of the indicator molecules. Those measures are, however, not suitable for substantially enhancing the photostability of the membrane per se. Finally, Jensen in U.S. Pat. No. 5,242,835 describes a method for determining the concentration of oxygen in a sample by detecting the emission of the singlet oxygen itself, which is excited by energy transmission during the extinction of the luminescence, occurring at a wavelength of approximately 1270 nm. Also, that method is prone to photodecomposition of the indicator or the matrix by exactly that reactive singlet oxygen, the latter returning into its ground state without radiation during a photochemical reaction, thus causing also the sensitizer molecules (indicators) serving the production of the singlet oxygen to be attacked.

None of the prior art discussed above, or known to the inventor, discloses the coating material for optical oxygen sensors with the enhanced sensitivity of the present application.

### OBJECTS AND SUMMARY OF THE INVENTION

The new process of this disclosure produces a matrix or medium for fabrication of optical sensors for monitoring small partial pressures of oxygen in gas and in liquid (ppm levels in gas and ppb levels of dissolved oxygen(DO) in liquids). The process enables the immobilization of highly oxygen sensitive Pt compounds into highly stable inorganic support matrix (sol gel). There are several advantages of this approach over conventional sensors using polymers as support matrix for platinum compounds.

Advantages over currently available products include the fact that the sol gel method of manufacture produces an optically transparent and inorganic glass with enhanced chemical, mechanical and photochemical stability, the process is carried out at room temperature and therefore allows for the encapsulation of previously impossible dopants and additives to said glass due to temperature constraints, and that the sol gel process of this invention exhibits excellent compatibility and adhesion with and to optical fibers that enables an ideal optical and mechanical coupling of a sensor transducer to said optical fibers.

The sol gel matrix may include or contain physically trapped dye molecules. These dye molecules are entered into the sol gel matrix without any chemical reaction between the dye and the host matrix and therefore said dye retains its inherent optical properties. The encapsulation of dye and other photoactive materials enables for extremely thin film formation that reduces the diffusion time and hence reduced sensor response time.

The disclosed process produces a matrix or medium for fabrication optical chemical sensors utilizing a room temperature process that allows for various doping possibilities including dyes, photoactive materials such as platinum or ruthenium, and allowing for extremely thin film deposition. The material is optically clear with enhanced chemical and mechanical and photochemical stability. The process also flexible with regards to interactions with various active chemicals and therefore allows for a wide variety of dopants.

Thus it is an object of this invention to disclose a process that produces a matrix or medium for fabrication optical chemical sensors that result in the production of extremely clear, high purity sol gel derived glass.

Its is another object of the invention to provide for a sol gel process that produces a mechanically and photochemically stable glass matrix at room temperature.

It is another object of this invention to provide a stable sol gel matrix that is easily applied to optical fibers and sensors.

It is yet another object of the invention to provide a process for the manufacture of a sol gel matrix that contains dyes, indicators, photoactive moieties, or other doping agents without the risk of chemical interaction or temperature degradation.

Its is still yet another object of the invention to provide said sol gel process wherein said sol gel matrix may be applied with doping agents in a very thin film to the end of an optical fiber or other traducer type device thereby reducing the transduction time.

### BRIEF DESCRIPTION OF THE DRAWINGS

These and other advantages of the invention may be more clearly understood with reference to the Specification and the drawings, in which:

FIG. 1. Is a graph of the dynamic response of sensor showing fluorescence intensity v.s. time.

FIG. 2. Is a graph of the dynamic response of sensor showing the fluorescence intensity change with 10 ppm O2 gas (0.001 Mole %).

### DETAILED DESCRIPTION OF THE INVENTION

The fiber optic sensor elements of a preferred embodiment of the present invention employ the sol-gel technique to encapsulate fluorescence material sensitive to oxygen. The sol gel technique is well known in the art. An explanation of the usual process is contained in “Sol-gel Coating-based Fiber Optic O2/DO sensor,” M. R. Shahriari, J. Y. Dings, J. Tongs, G. H. Sigel, International Symposium on Optical Tools for Manufacturing and Advanced Automation, Chemical, Biomedical, and Environmental Fiber Sensors, Proc. SPIE, V0l. 2068 (1993).

There are various routes to the manufacture of sol-gel matrices, which are known to the art. Common starting materials are tetraethyl orthosilicate (TEOS) and tetramethy orthosilicate (TMOS). A common route is to mix a metal siloxane and solvent with any desired modifiers or additives and/or dopants. This sol is then encouraged to form a gel via hydrolysis with subsequent polycondensation forming certain intermediate silicate fractals, monomers, and ultimately a rigid gel structure with high porosity.

The object of this invention is a process that produces a matrix or medium for fabrication of optical sensors for monitoring small partial pressures of oxygen in gas and in liquid. The process enables the immobilization of highly oxygen sensitive Pt compounds into highly stable inorganic support matrix (sol gel). There are several advantages of this approach over conventional sensors using polymers as support matrix for Pt compounds. Some of advantages include: 1) Sol gel is an optically transparent inorganic glass with enhanced chemical, mechanical and photochemical stability, 2) Sol gel is a room temperature process that allows encapsulation of temperature sensitive dyes, 3) Sol gel has excellent compatibility and adhesion with optical fibers and can be coated as thin film on optical fibers enabling ideal optical and mechanical coupling of sensor transducer to optical fibers, 4) Sol gel physically traps dye molecules and does not involve any chemical reaction between dye and host matrix and hence enables dyes to retain their optical properties. Thin film coating also reduces the diffusion time and hence reduces sensor response time.

The preferred embodiment of the invention involves the following steps: (1) Addition of sol gel precursors to water and alcohol for fabricating a multi-component sol-gel medium. Alcohol is used as a mutual solvent for water and the precursor, (2) Selecting a 2^{nd} mutual solvent to dissolve non-water/non-alcohol soluble Pt compounds [Pt(II) Octaethylporphine and Pt(II) meso-Tetra (pentafluorophenyl)], (3) mixing appropriate amounts of Pt solution to sol gel solution, (4) coating the doped sol gel on optical fibers, and (5) thermal and optical curing of coating.

During the manufacture of the sol-gel membrane of the present invention, the indicator molecules are added. Platinum complexes may be added to impart the optical sensor component of the clear and mechanically stable sol gel matrix. In making the preferred embodiment, a Pt(II) Octaethylporphine and Pt(II) meso-Tetra (pentafluorophenyl is added to the solution and dispersed via mixing prior to gel formation. We have found that vigorous mixing of the sol and Pt(II) Octaethylporphine and Pt(II) meso-Tetra (pentafluorophenyl) together is adequate to disperse said Platinum complexes throughout the sol-gel material appropriately.

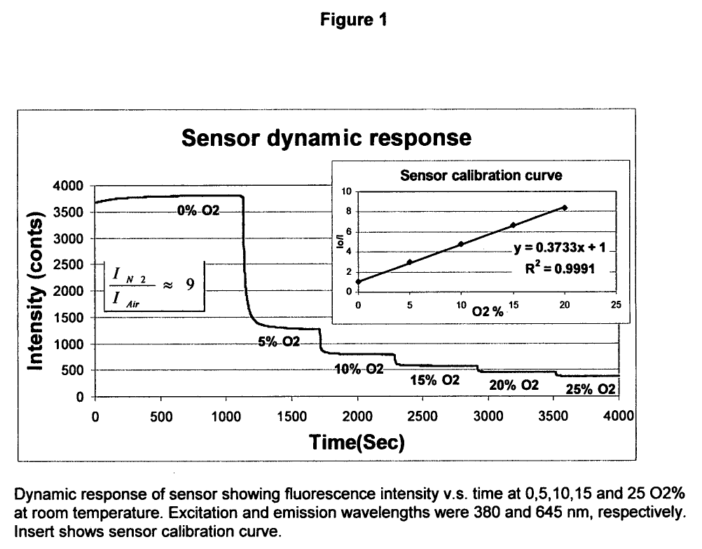

The process of this invention has been used to create fiber optic oxygen probes with specialized coatings. These new sensors were exposed to a gas mixture that contained various concentrations of oxygen. FIG. 1 shows the dynamic response of sensor between 0 and 25% (vol. %) at room temperature. A 380 nm LED is used as the excitation source and emission intensity is recorded at 645 nm. Dynamic response is used to calibrate the sensor. The insert in FIG. 1 shows the calibration curve using the Stem Volmer relation. As shown in FIG. 1 sensor calibration between 0 and 20% O2 followed closely with the Stem Volmer linear relation

$$\{ \frac{{I}_{o}}{I} = 1 + {K}_{sv} ( {p}_{O 2} ) \} .$$

The sensor sensitivity

$$\frac{{I}_{N 2}}{{I}_{air}}$$

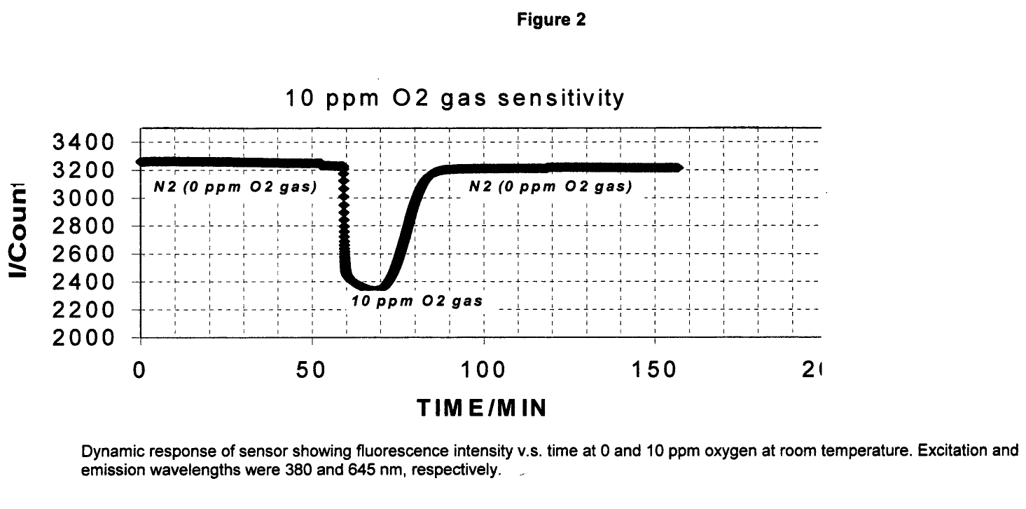

is about 9 as indicated in FIG. 1. FIG. 2. shows the dynamic response of sensor showing the fluorescence intensity change with 10 ppm O2 gas (0.001 Mole %). This figure indicates the capability of sensor monitoring O2 gas at low concentrations down to 10 ppm levels.

It is to be understood that the present invention is not limited to the methods described above, but encompasses any and all methods within the scope of the following claims.

The following is claimed:

1. A method of making an enhanced membrane which can be coated on optical fibers for detecting the presence of an analyte in a sample utilizing a solution of monomers which serves as a precursor to the membrane, comprising:
adding of sol-gel precursors to water and alcohol for fabricating a multi-component sol-gel medium wherein the alcohol is used as a mutual solvent for water and the precursor;
selecting a second mutual solvent to dissolve non-water/non-alcohol soluble Platinum compounds creating a Platinum solution;
mixing appropriate amounts of said Platinum solution to said multi-component sol-gel medium creating a doped sol-gel;
thin film coating of said doped sol-gel on optical fibers; and, thermal and optical curing of said doped sol-gel thin film coating.

2. The method of claim 1 wherein said Platinum compounds are comprised of Pt(II) Octaethylporphine and Pt(II) meso-Tetra (pentafluorophenyl).

3. The method of claim 1 wherein said sol-gel precursors are comprised of tetraethyl orthosilicate (TEOS) and tetramethy orthosilicate (TMOS).

4. The method of claim 1 wherein the analyte to be detected is oxygen.

5. An analyte detecting device made by the process of claim 1.
